(19) United States
(12) Patent Application Publication
(10) Pub. No.: US 2025/0012416 A1
(43) Pub. Date: Jan. 9, 2025

(54) OUTDOOR LIGHTING SYSTEM

(71) Applicant: Edward D'Angelo Johnson, Meriden, CT (US)

(72) Inventor: Edward D'Angelo Johnson, Meriden, CT (US)

(21) Appl. No.: 18/752,763

(22) Filed: Jun. 24, 2024

Related U.S. Application Data
(60) Provisional application No. 63/509,657, filed on Jun. 22, 2023.

(51) Int. Cl. F21S 9/03; F21S 8/00; F21V 23/04; F21Y 107/50; F21Y 115/10

(52) U.S. Cl. CPC F21S 9/037; F21S 8/036; F21V 23/0464; F21Y 2107/50; F21Y 2115/10

(57) ABSTRACT

An outdoor lighting system for illuminating decks and pathways outdoors. The outdoor lighting system includes an elongated base. One or more solar panels are mounted to an upper-end portion of the base. Multiple lights are coupled to the lower-end portion of the base. The lights are powered by solar energy. For mounting brackets coupled to the base are for mounting the outdoor lighting system to a deck.

### CROSS-REFERENCE TO RELATED APPLICATIONS

This application claims priority from a U.S. Provisional Patent Appl. No. 63/509,657, filed on Jun. 22, 2023, which is incorporated herein by reference in its entirety.

### FIELD OF INVENTION

The present invention relates to outlook lighting, and more particularly, the present invention relates to outdoor lights with wider illumination.

### BACKGROUND

Outdoor lights typically cover all types of lights used outdoors. This includes lights used outdoors to enhance the aesthetic appearance of a house. Also, lights are used in gardens, decks, and pathways to illuminate the same in the dark. The outdoor lights for illuminating the decks and pathways at night are essential so that people can see where they are walking. However, the present outdoor lights suffer from several limitations. Primarily, the lights cannot illuminate the whole path or decks due to the poor intensity of light. Also, the outdoor lights do not stay lit for long periods.

A need is therefore appreciated for an outdoor lighting system that overcomes the aforesaid drawbacks with conventional outdoor lights.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an outdoor lighting system that can stay lit for longer durations.

Another object of the present invention is that the outdoor lighting system can illuminate wide areas.

Still, another object of the present invention is that the outdoor lighting system can be powered by renewable energy.

Yet another object of the present invention is that the outdoor lighting system is easy to install.

In one aspect, disclosed is an outdoor lighting system comprising an elongated base having an upper-end portion and a lower-end portion; one or more solar panels mounted on the upper-end portion; a plurality of front lights mounted to a front side of the lower-end portion of the elongated base; and a plurality of rear lights mounted to a rear side of the lower-end portion of the elongated base. The outdoor lighting system further comprises a light sensor configured to detect environmental light. The outdoor lighting system further comprises one or more batteries. The outdoor lighting system further comprises a plurality of mounting brackets for mounting the outdoor lighting system to a supporting structure. The plurality of mounting brackets comprises four mounting brackets coupled to the elongated base. The supporting structure is a fence. The plurality of front lights and the plurality of rear lights are LEDs.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 shows a side view of the outdoor lighting system, according to an exemplary embodiment of the present invention.

FIG. 2 shows a top view of the outdoor lighting system, according to an exemplary embodiment of the present invention.

FIG. 3 is a bottom view of the outdoor lighting system, according to an exemplary embodiment of the present invention.

FIG. 4 is a front view of the outdoor lighting system, according to an exemplary embodiment of the present invention.

FIG. 5 is a rear view of the outdoor lighting system, according to an exemplary embodiment of the present invention.

FIG. 6 is a perspective view of the outdoor lighting system, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The described invention pertains to an outdoor lighting system that can be powered by Solar energy and can illuminate a wider area for longer durations. By utilizing solar energy, the disclosed outdoor lighting system can save a lot of electricity and stay lit all night. By including a larger number of lights and positioning the lights on two sides, the disclosed outdoor lighting system can light a wider area providing clear visibility at night.

The disclosed outdoor lighting system can be used to light pathways and decks. The person walking on the pathways and deck can see where they are walking, thus preventing any accident.

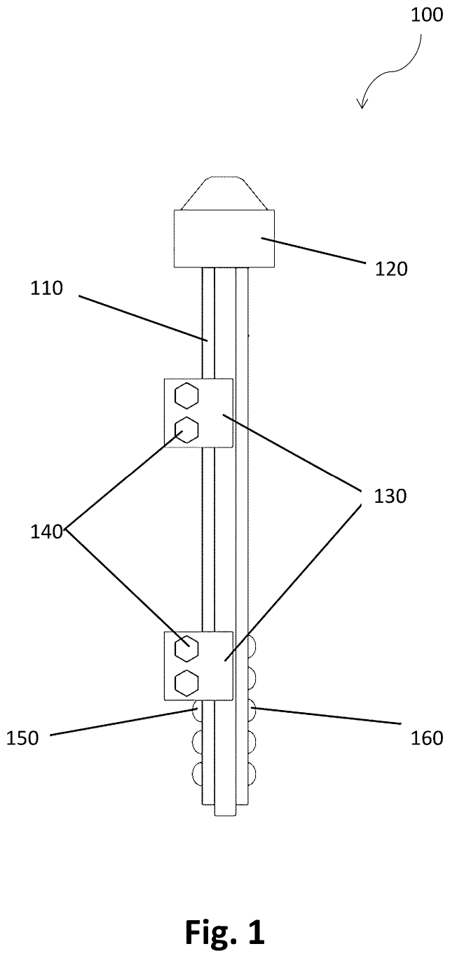

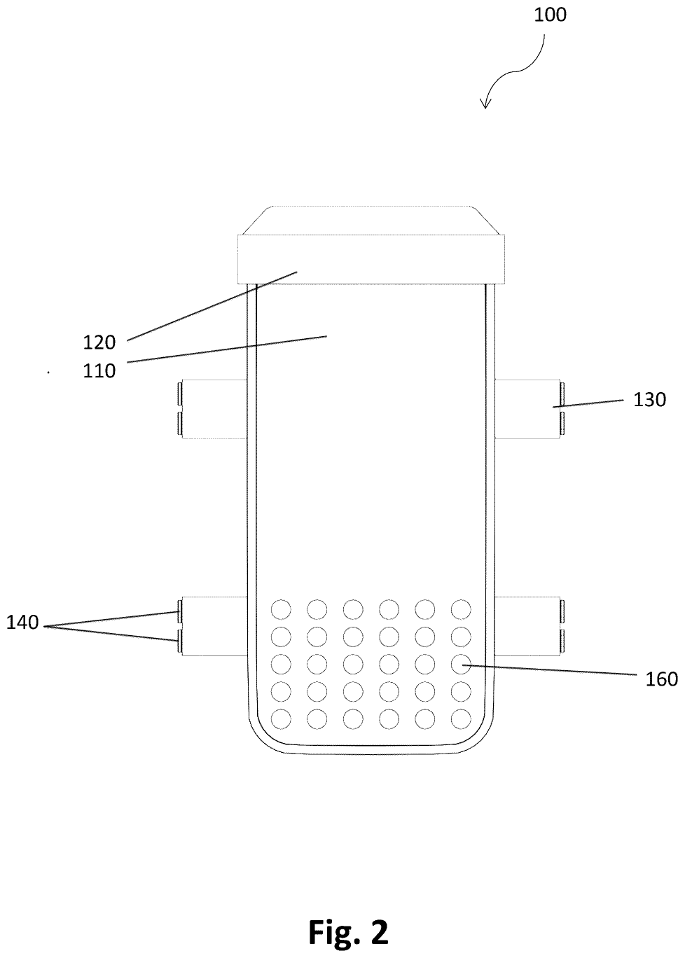

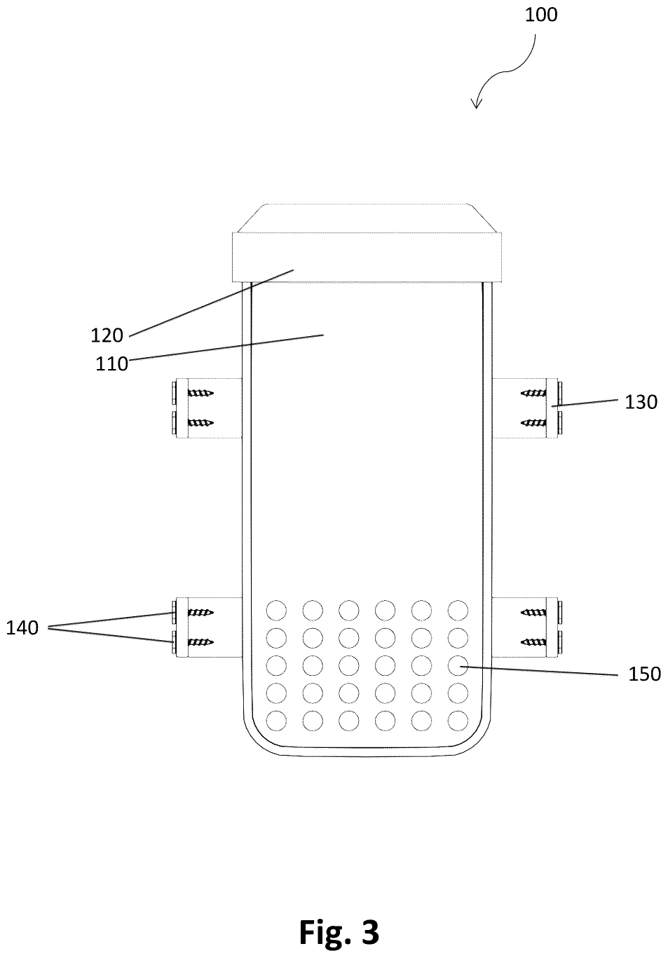

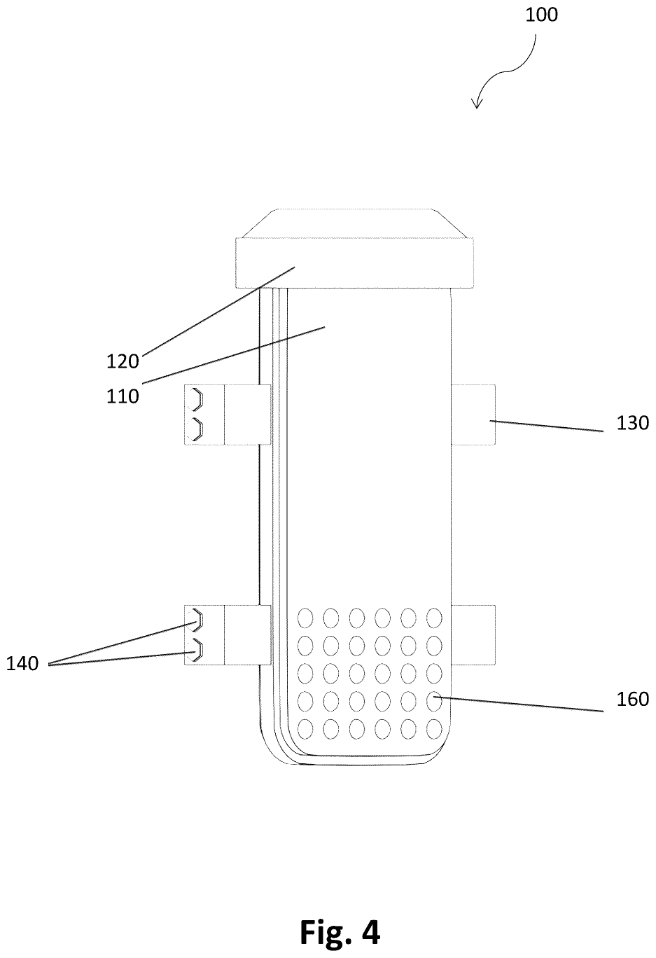

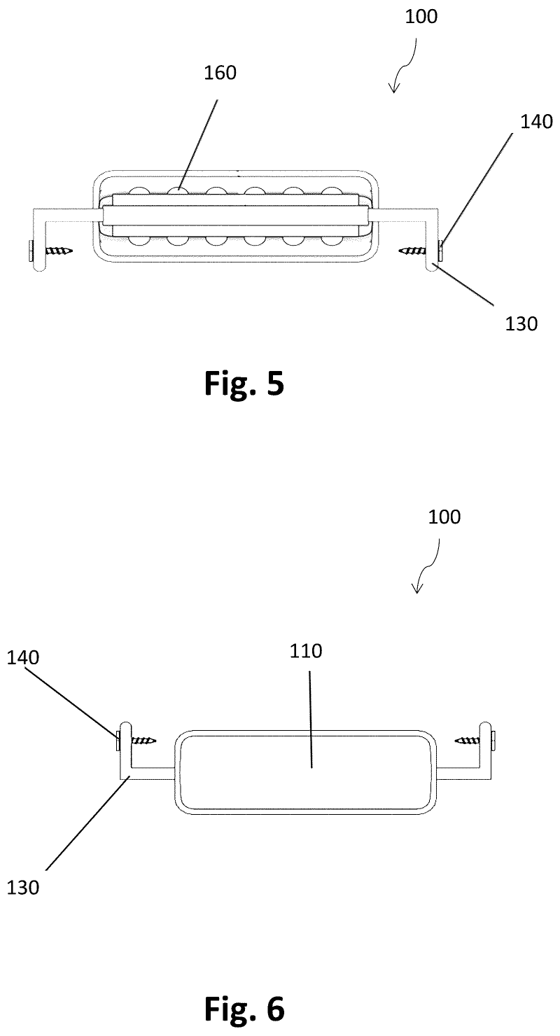

Referring to FIGS. 1-6 which illustrate different views of the disclosed outdoor lighting system. The outdoor lighting system includes an elongated support base to which different components can be mounted. The elongated support base can be oriented vertically with an upper-end portion at the top and a lower-end portion at the bottom of the elongated support base. The base can be made from any suitable material, such as wood and plastic. Preferably, the material can be weather-resistant and have good durability. In the drawings, the base is shown to have a rectangular shape, however, the structure of the base can vary without departing from the scope of the present invention. The width and height of the base may depend upon the supporting structure to which the outdoor lighting system has to be mounted, such as outdoor deck fencing.

One or more solar panels can be mounted to the upper-end portion of the base. Multiple mounting points for solar panels can be provided in the base so that the position of the solar panels can be adjusted for maximum sun exposure.

Mounting brackets can be used for mounting the outdoor lighting system to a supporting structure. The mounting brackets can be coupled to the base. The drawings show brackets 130 coupled to the left and right sides of the base and extending perpendicularly to the plane of the base and rearwards. The mounting brackets shown in the drawings may help to mount the system to outdoor deck fencing. Screws 140 can be used to secure the system to the fencing. It is envisioned that the position of the mounting brackets can be adjusted relative to the base. This makes the system more versatile in installation over a wide variety of supporting structures. The drawings show rectangular-shaped mounting brackets coupled to the base. Two screws are placed into each mount for an extra sturdy hold.

Lighted can be disposed on the lower end portion of the base. Front lights 160 can be installed on the front side of the lower end portion of the base and rear lights 150 can be installed on the rear side of the lower end portion of the base. The lights can preferably be LED lights, however, any type of light is within the scope of the present invention.

In certain implementations, the lights can be powered by the solar energy collected by the solar panels. The system may also include suitable batteries to store solar energy. It is to be understood that any type of energy storage including batteries is within the scope of the present invention. Also, any type of battery can be used without departing from the scope of the present invention.

The disclosed system can project full-coverage light to better illuminate the area and provide a safer environment for homeowners. The drawings show five mini rows of lights located at the bottom of the base. A light sensor can be used to automatically turn the light on when it is dark and turn off the light in the morning. The described system is easy to use and install. The system can light up all areas of the deck and its surroundings. The system can provide its ambiance/aesthetic look.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An outdoor lighting system comprising:
an elongated base having an upper-end portion and a lower-end portion;
one or more solar panels mounted on the upper-end portion;
a plurality of front lights mounted to a front side of the lower-end portion of the elongated base; and
a plurality of rear lights mounted to a rear side of the lower-end portion of the elongated base.

2. The outdoor lighting system of claim 1, wherein the outdoor lighting system further comprises:
a light sensor configured to detect environmental light.

3. The outdoor lighting system of claim 1, wherein the outdoor lighting system further comprises:
one or more batteries.

4. The outdoor lighting system of claim 1, wherein the outdoor lighting system further comprises:
a plurality of mounting brackets for mounting the outdoor lighting system to a supporting structure.

5. The outdoor lighting system of claim 1, wherein the plurality of mounting brackets comprises four mounting brackets coupled to the elongated base.

6. The outdoor lighting system of claim 4, wherein the supporting structure is a fence.

7. The outdoor lighting system of claim 4, wherein the plurality of front lights and the plurality of rear lights are LEDs.
